(19) United States
(12) Patent Application Publication
(10) Pub. No.: US 2019/0105865 A1
(43) Pub. Date: Apr. 11, 2019

(54) MACHINE FOR CONVERTING SPOOLED MATERIAL INTO DUNNAGE

(71) Applicant: Adam Kelley, Vista, CA (US)

(72) Inventor: Adam Kelley, Vista, CA (US)

(21) Appl. No.: 16/158,255

(22) Filed: Oct. 11, 2018

Related U.S. Application Data
(60) Provisional application No. 62/570,948, filed on Oct. 11, 2017.

(51) Int. Cl. B31D 5/00; B29C 65/00

(52) U.S. Cl. CPC B31D 5/0052; B29C 66/735; B31D 2205/0023; B31D 2205/0082; B31D 2205/0058; B31D 2205/007; B31D 2205/0047

(57) ABSTRACT

The disclosure concerns a machine for converting spooled material into dunnage for use with packaging and shipping of goods. The machine is capable of adjustably changing a thickness and/or density of dunnage created therefrom. The machine includes adjustable posts for configuring a size and density of the dunnage produced. Additionally, a dunnage roller system reuses a belt to both drive the rollers and to carry the spooled material through the machine as it becomes dunnage.

### CROSS-REFERENCE TO RELATED APPLICATIONS

This application claims benefit of priority with U.S. Provisional Application Ser. No. 62/570,948, filed Oct. 11, 2017; the entire contents of which are hereby incorporated by reference.

### BACKGROUND OF THE INVENTION

### Field of the Invention

This invention relates to packaging machines, and more particularly to an improved machine for converting spooled material into dunnage.

### Description of the Related Art

Dunnage is material used inside packages and containers to protect goods and their packaging from mechanical damage. Dunnage may include, inter alia, various foams, packaging peanuts, cloth, wood, or paper. Spooled materials including paper, foam, and plastic films are favorable materials for use as dunnage because they can be purchased in large quantities for relatively inexpensive cost, and many are lightweight for maintaining low shipping costs.

Spooled material can be converted into Dunnage by hand, for example, one might purchase a spool of paper, crumple said paper by hand, and use the paper to protect an item inside a package during shipment. One problem is that crumpling paper by hand is somewhat tedious, adding considerable labor costs to a company that ships large quantities of items. In addition, and perhaps more importantly, hand-crumbling is significantly more time consuming than automated dunnage, such as using a machine.

Industrial dunnage machines are well known and used in the art. The recent explosion of internet commerce (“e-commerce”) has created a need to safely package and ship large quantities of items quickly and efficiently.

This demand has led to a myriad of industrial machines to streamline the packing process. Everything from giant packaging peanut funnels, to completely automated packaging devices form a very crowded art of bulky or expensive industrial machines. However, there remains a need for a simple, efficient solution, to provide dunnage material both quickly and efficiently. These needs are addressed by the disclosure provided herein and directed to one having skill in the art for making and using machines for converting spooled material into dunnage.

### SUMMARY OF THE INVENTION

The disclosure concerns a machine for converting spooled material into dunnage. The machine includes a head unit with a stand and a spool basket. The head unit of the machine further includes: a housing; a belt-driven dunnage roller system; and a spring mounted counter roller. The housing includes: an entrance; an exit; and a passage extending therethrough. Additionally, the head unit includes: an adjustable lateral entrance adjacent to a first side of the housing; a feeding tray adjacent to the adjustable lateral entrance; and a cutter adjacent to the exit of the housing.

The machine for converting spooled material into dunnage product is characterized in that the spooled dunnage material is configured to be routed from the spool over the feeding tray, and into the adjustable lateral entrance of the housing. When the dunnage material encounters the walls of the adjustable lateral entrance of the housing, the material will fold in on itself, thus crumpling the dunnage material laterally. Next, the dunnage material passes between the belt-driven dunnage roller and the spring-mounted counter roller, crumpling the dunnage material vertically. Finally, the dunnage roller drives the now converted dunnage product through the exit of the housing, thus allowing a user to extrude and cut a desired amount of dunnage product from the machine. In this regard, the machine provides additional freedom to configure the physical characteristics (size, shape, etc.) of the dunnage product as-produced by the machine.

### BRIEF DESCRIPTION OF THE DRAWINGS

FIG. 1 shows a front perspective view of a machine for converting spooled material into dunnage in accordance with a first embodiment; the machine includes a head unit, a spool basket, and a stand.

FIG. 2 shows a front view of the machine in accordance with the first embodiment;

FIG. 3 shows a right-side view of the machine in accordance with the first embodiment;

FIG. 4 shows a rear view of the machine in accordance with the first embodiment;

FIG. 5 shows a left-side view of the machine in accordance with the first embodiment;

FIG. 6A shows a side view of the head unit of the machine in accordance with the first embodiment;

FIG. 6B shows a cross-sectional side view of the head unit of the machine in accordance with the first embodiment; wherein the head unit includes: a housing; a belt-driven dunnage roller system; and a spring-mounted counter roller each mounted therein;

FIG. 7A shows a perspective side view of the head unit of the machine in accordance with the first embodiment;

FIG. 7B shows a cross-sectional perspective view in accordance with the first embodiment; wherein the head unit includes a housing, the machine having a belt-driven dunnage roller system and a spring-mounted counter roller mounted therein;

FIG. 8A shows a perspective view a spool basket in accordance with the first embodiment;

FIG. 8B shows a top view of a spool basket in accordance with the first embodiment;

FIG. 9A shows a front view of the head unit of the machine in accordance with the first embodiment; the head unit including two posts adjustably-disposed at the adjustable lateral entrance of the head unit, with each post positioned on an opposite side of the opening;

FIG. 9B shows another view of the head unit of the machine in accordance with the first embodiment; wherein one of two posts is shown being adjustably-disposed and reconfigurable at the adjustable lateral entrance of the head unit;

FIG. 10A shows a side view of the belt driven dunnage roller system in accordance with the first embodiment;

FIG. 10B shows a perspective view of the belt driven dunnage roller system in accordance with the first embodiment; and

FIG. 10C shows a perspective side view of a dunnage roller with integrated channel extending along an outer surface thereof.

### DETAILED DESCRIPTION OF THE PREFERRED EMBODIMENTS

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review hereof. Accordingly, any reviewer of the instant disclosure should interpret the scope of the invention by the claims, and such scope is not intended to be limited by the embodiments described and illustrated herein.

### General Embodiment

In a general embodiment, a machine for converting spooled material into dunnage includes a head unit, a stand, and a spool basket. The head unit generally includes: a housing, a belt-driven dunnage roller system, and a spring-mounted counter roller. The housing includes: an entrance; an exit; and a passage extending therethrough. Additionally, the head unit includes: an adjustable lateral entrance adjacent to a first side of the housing, a feeding tray adjacent to the adjustable lateral entrance, and a cutter adjacent to the exit of the housing.

The machine for converting spooled material into dunnage product is characterized in that the spooled dunnage material is configured to be routed from the spool over the feeding tray, and into the adjustable lateral entrance of the housing. When the dunnage material encounters the walls of the adjustable lateral entrance of the housing, the material will fold in on itself, thus crumpling the dunnage material laterally. Next, the dunnage material passes between the belt-driven dunnage roller and the spring-mounted counter roller, crumpling the dunnage material vertically. Finally, the dunnage roller drives the now converted dunnage product through the exit of the housing, thus allowing a user to extrude and cut a desired amount of dunnage product from the machine.

### Commercial Embodiment

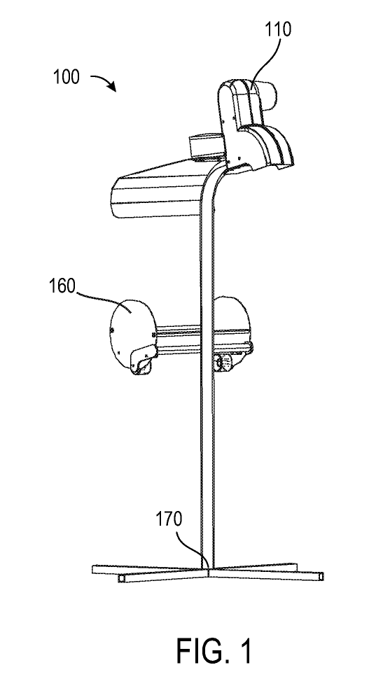

Turning to the drawings, FIG. 1 shows a front perspective view of a machine for converting spooled material into dunnage 100 in accordance with a first commercial embodiment; the machine for converting spooled material into dunnage 100 is shown including a head unit 110, an optional spool basket 160, and an optional stand 170. While not required, the optional spool basket and optional stand will be provided in the preferred embodiment as-illustrated.

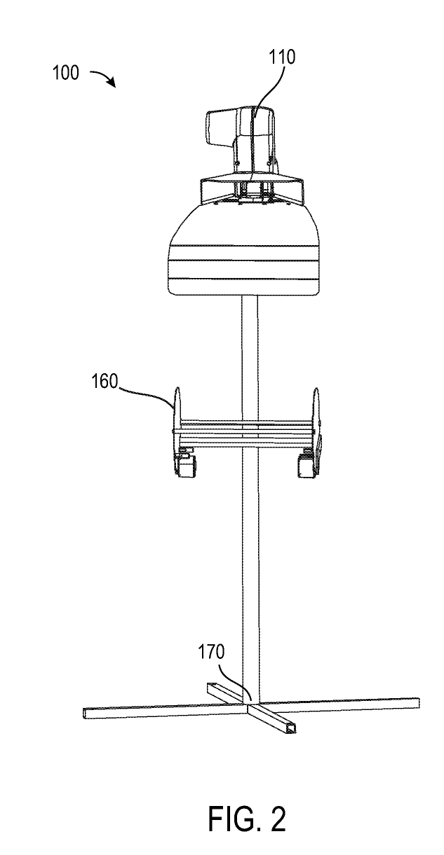

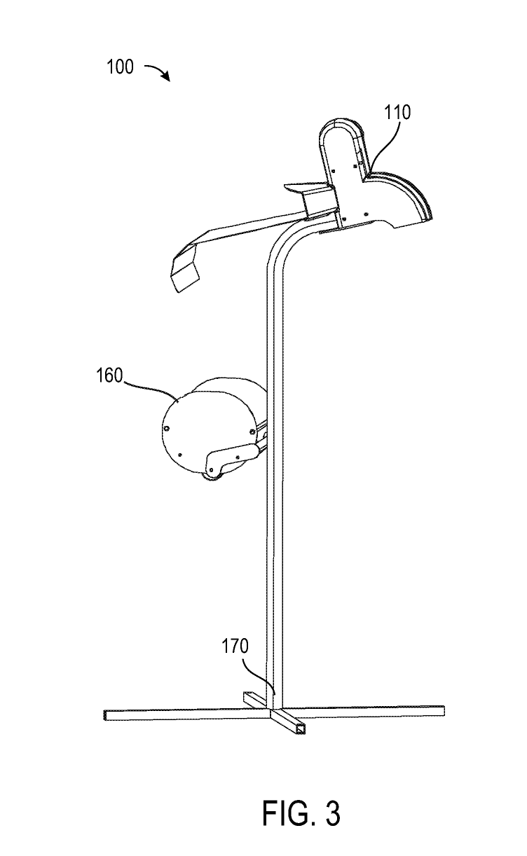

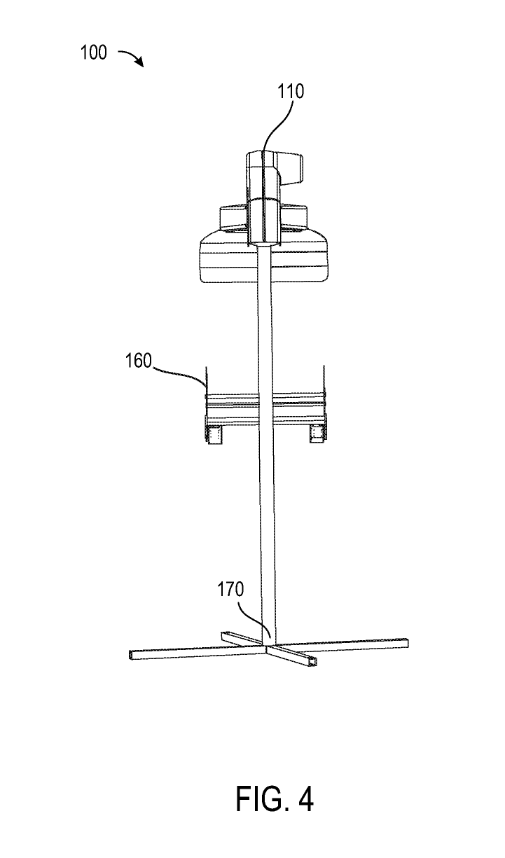

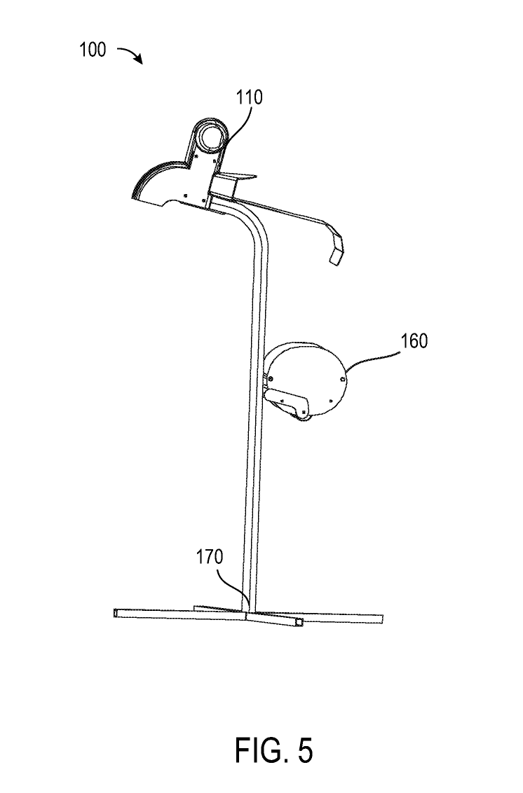

FIG. 2-FIG. 5 show various views of the machine in accordance with the first embodiment, wherein: FIG. 2 shows a front view; FIG. 3 shows a right-side view; FIG. 4 shows a rear view; and FIG. 5 shows a left-side view of the machine for converting spooled material into dunnage product. The head 110, spool basket 160, and stand 170 are shown in each figure, respectively.

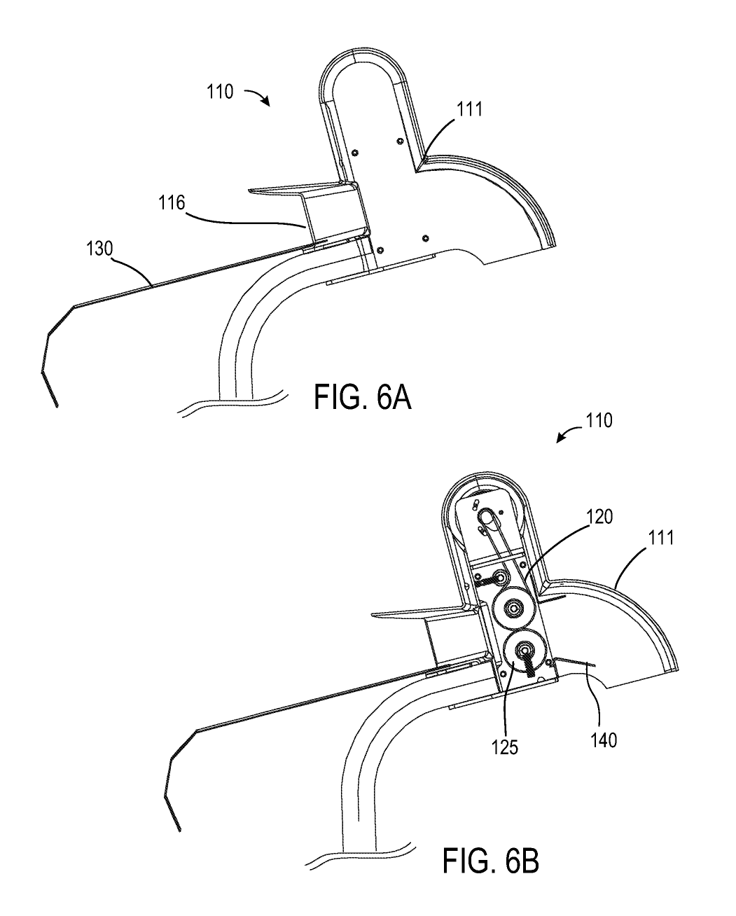

FIG. 6A shows a side view of the head unit 110 of the machine in accordance with the first embodiment. Here, the housing 111 is shown. The housing is shown including an adjustable lateral entrance 116, with a feeding tray 130 mounted to the housing. The feeding tray is utilized to direct the spooled product, namely spooled paper, into the adjustable lateral entrance of the machine where it will be subsequently crumpled.

FIG. 6B shows a cross-sectional side view of the inside componentry of the head unit 110. Here, the head unit 110 componentry includes: a belt-driven dunnage roller system 120 and a spring-mounted counter roller 125, with each component thereof being mounted inside the housing 111 and configured to apply pressure while rotationally driving spooled material through the head unit. Additionally, a cutter 140 is shown disposed at the exit of the housing for cutting the crumpled dunnage product at the exit of the machine.

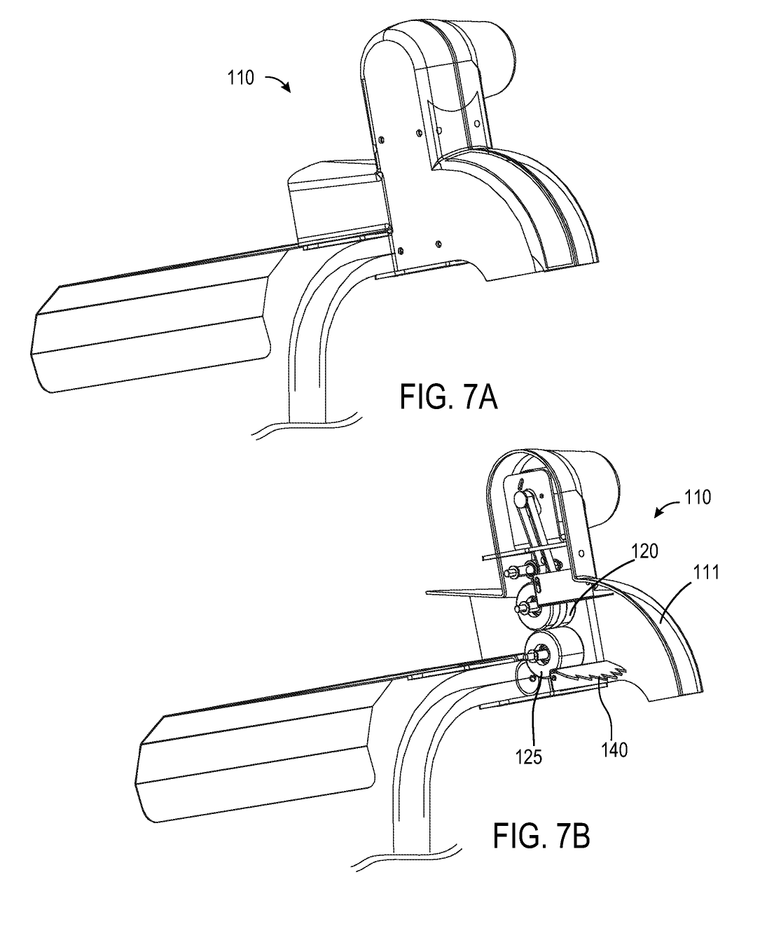

FIG. 7A shows a perspective view of the head unit 110 of the machine in accordance with the first embodiment.

In order to appreciate the workings of the head unit, FIG. 7B shows another view of the head unit 110; wherein the head unit includes: a belt-driven dunnage roller system 120 and a spring-mounted counter roller 125, with each being mounted inside the housing 111 and configured to drive the spooled material and convert it into dunnage product as it passes through the head unit. Again, the cutter 140 is shown disposed at the exit of the housing.

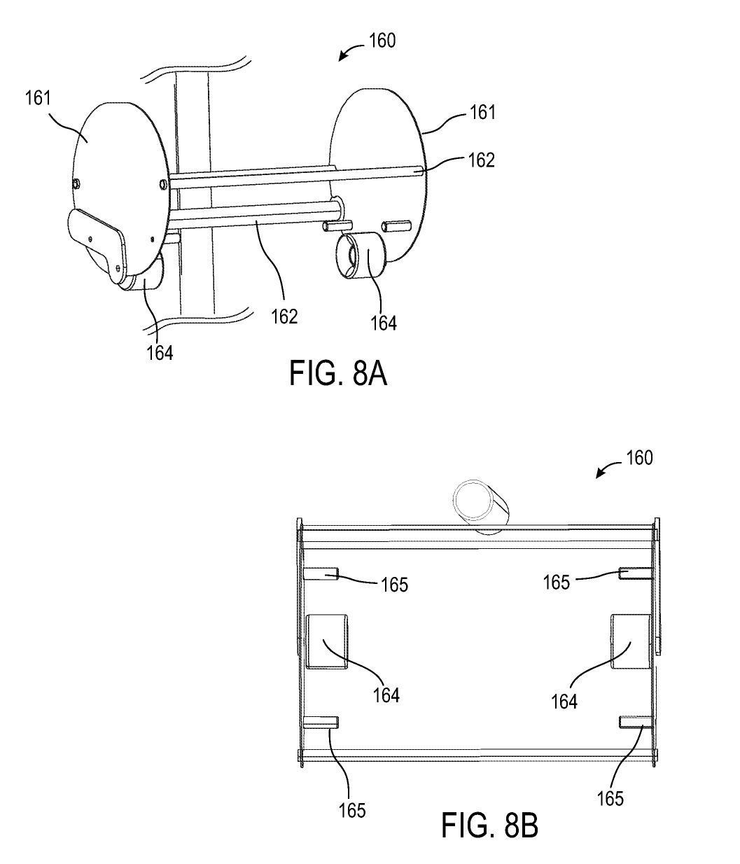

FIG. 8A shows a perspective view of the spool basket 160 in accordance with the first embodiment. The spool basket 160 may be formed by a plurality of vertically aligned plates 161 being coupled together via a plurality of horizontally extending bars 162. The spool basket further includes a plurality of wheels 164 each being mounted inside the spool basket and configured for rotational movement such that a spool of material, such as various paper products, can be placed inside the basket and can rotate with negligible resistance inside the basket atop the plurality of wheels. While the preferred embodiment includes wheels, it is contemplated in other embodiments that wheels may be omitted without departing from the spirit and scope of the invention.

FIG. 8B shows a top view of a spool basket 160 in accordance with the first embodiment. Here, the plurality of wheels 164, are shown positioned between securing arms 165 for receiving a spool of material, i.e. spooled paper. The basket can be mounted to the stand via an attachment collar.

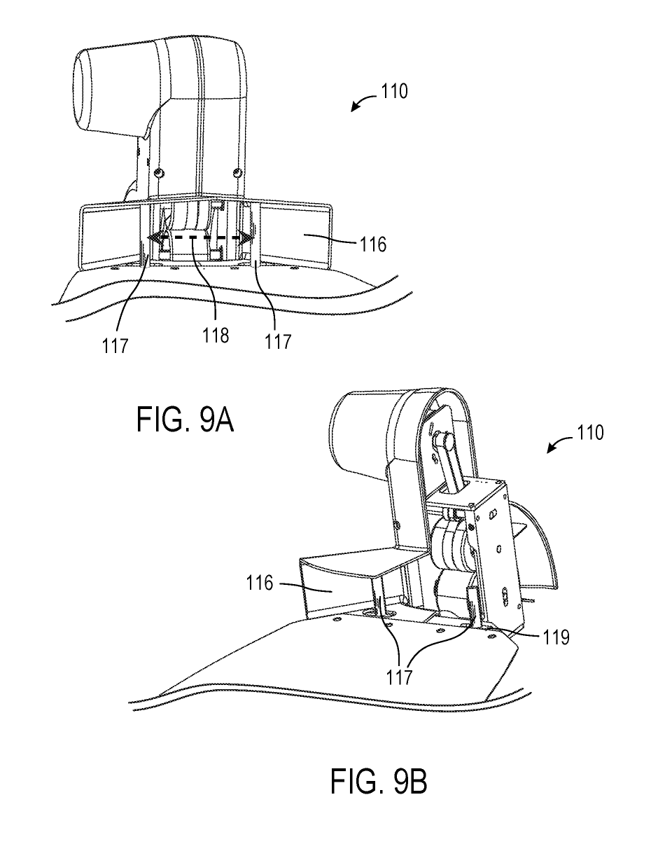

FIG. 9A shows a rear view of the head unit 110 of the machine in accordance with the first embodiment; the head unit including a plurality of posts 117, each post being adjustably disposed inside the adjustable lateral entrance 116 of the head unit, with each post positioned on an opposite side of the opening. The posts can be adjusted to establish a desired distance 118 between posts, such that the paper can be laterally folded to a dunnage volume as may be desired by a user. To provide the adjustable positioning of the posts, each post may be secured to the head unit at a slot (119, FIG. 9B), the slot extending laterally at the opening and disposed through the housing as shown, such that the lateral position of the post is capable of being configured by a user, for example, by tightening a nut with the post being located at the desired lateral position of the slot, or using any conventional technique as may be appreciated by one with skill in the art. Each post may be laterally configured at a desired position, thereby adjustably configuring a dunnage volume of the dunnage product produced by the machine.

FIG. 9B shows a sectioned view of the head unit 110 of the machine in accordance with the first embodiment; with each of the posts 117 being adjustably configured about the adjustable lateral entrance 116 of the head unit. Here, the slot 119 is shown with the one of the posts 117 being positioned as desired thereon. Various mechanisms can be implemented by one having skill in the art such that a position of the post reconfigurable according to the preference of a user.

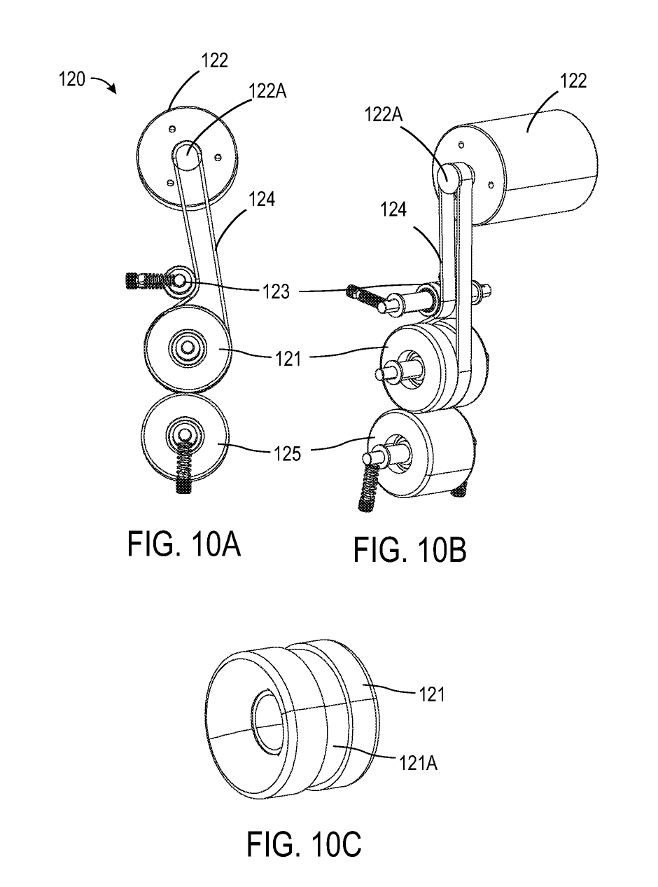

FIG. 10A shows a side view of the belt-driven dunnage roller system 120 in accordance with the first embodiment. As shown, a motor 122 includes a driving element 122a, wherein a belt 124 is coupled to the driving element of the motor and configured to translate as the driving element rotates. The belt 124 extends to a first roller 121, the first roller including a channel (121a, FIG. 10C) extending about a circumference thereof, wherein the belt is configured to nest within the channel of the first roller and a surface of the belt is configured to form a flush surface with the surface of the roller (not including the channel) for contacting the spooled material as it moves through the belt-driven dunnage roller system. A tensioning roller 123 is used to adjust the tension on the belt. Adjacent to the first roller 121 is a second roller 125, which is not directly driven by the belt 124 but which is spring mounted to provide a bias force against the first roller of the head unit and configured with a surface for resting against the first roller in order to grip and pass paper through the head unit. The bias force of the second roller can be applied to press the second roller 125 against the first roller 121 thereby ensuring a sufficient grip for passing the paper through the system.

FIG. 10B shows a perspective view of the belt driven dunnage roller system 120 in accordance with the first embodiment. Each of the motor 122, driving element 122a, belt 124, first roller 121, channel 121a, second roller (spring-mounted roller) 125, springs and axels thereof are illustrated.

FIG. 10C shows a perspective side view of a first roller (dunnage roller) 121 with integrated channel 121a extending along an outer surface thereof. The channel generally comprises a width slightly larger than a width of the belt, and a depth can be slightly larger than the belt thickness.

### Other Embodiments and Features

The head unit includes a housing formed by a plurality of plates. The plates may be formed to contour the components contained inside the housing, to provide a relatively low profile.

The housing formed has an entrance, an exit, and a passage extending therethrough. A side of the entrance on the outside of the housing may be referred to herein as the first side of the entrance, and the side of the entrance on the inside of the housing may be referred to herein as the second side of the entrance. Adjacent to the first side of the entrance, a plurality of tapered walls may be disposed, the tapered walls can extend outwardly forming an adjustable lateral entrance. The adjustable lateral entrance acts to funnel spooled material into the entrance as the material approaches the entrance of the housing.

The components inside the housing form a belt driven dunnage roller system. The belt driven dunnage roller system may include: a dunnage roller, a motor, and a tensioner rotationally connected by a belt. Additionally, each component can be mounted for independent rotation inside the housing. The dunnage roller extends into the passage of the housing, adjacent to the second side of the entrance, inside of the housing.

The dunnage roller includes a first roller configured with a channel extending around an outer surface (circumference) of the wheel. The channel is configured to receive the belt such that when the motor pulls the belt, the belt will pull the first roller. By placing the belt in the channel on the outer surface of the first roller as opposed to a gear adjacent to the first roller, the surface of the belt helps the wheel grip the dunnage material, and easily drive the spooled material through the machine.

Additionally, a spring-mounted counter roller, is disposed adjacent to the entrance of the housing and below the dunnage roller. The spring-mounted counter roller is configured to abut the surface of the dunnage roller and rotate in a direction opposite the dunnage roller. Because the spring mounted roller is biased to provide a force against the dunnage roller, it also helps the dunnage roller grip and pass the spooled material as the dunnage roller drives it through the machine.

A feeding tray is disposed adjacent to the adjustable lateral entrance of the housing. The feeding tray extends outwardly from the entrance of the housing and guides the material from the spool to the entrance of the housing. The feeding tray provides support to the spooled material, allowing it to enter the adjustable lateral entrance at a proper angle.

A cutter is disposed adjacent to the exit of the housing. This cutter allows a user to safely and efficiently cut the newly extruded dunnage product. The cutter may comprise a piece of metal with a jagged, serrated, or otherwise sharpened edge.

Optionally, a spool basket may be provided. The spool basket can be formed by a plurality of plates coupled together via a plurality of bars. The spool basket further includes a plurality of wheels rotationally mounted inside the basket such that a spool of dunnage material can be placed inside the basket and can rotate inside the basket atop the plurality of wheels.

The machine for converting spooled material into dunnage is characterized in that a user can route spooled material from the spool, over the feeding tray, and into the adjustable lateral entrance of the housing, wherein when the spooled material encounters the walls and posts of the adjustable lateral entrance, the spooled material will fold into itself, crumpling the spooled material laterally, and wherein when the spooled material passes between the belt-driven dunnage roller and the spring-mounted counter roller disposed adjacent to the entrance, the belt driven dunnage roller engages the dunnage material, crumpling the dunnage material vertically against the spring mounted counter roller, simultaneously forcing the material through the passage of the housing and out through the exit. Accordingly, the machine allows a user to extrude a desired amount of dunnage product from the exit of the housing, and enables the user to cut the dunnage product via the cutter disposed adjacent to the exit of the housing.

Now, the density of the extruded dunnage product can be varied by adjusting the width of the material as it enters the housing and contacts the dunnage roller. Accordingly, adjacent to the entrance of the dunnage roller, between the dunnage roller and the funneled entrance, a plurality of adjustable posts can be provided. By varying the distance between these adjustable posts, the user can set the density of the extruded dunnage product. For example, by increasing the distance between the adjustable posts, the density of the extruded dunnage product will decrease, thereby producing a relatively thin dunnage product. Conversely, by decreasing the distance between the adjustable posts, the density of the extruded dunnage material will increase, thereby producing a relatively thick, but compact dunnage product. This allows the user to control the density of the dunnage product extruded by the machine.

The spooled material may be any material used as dunnage in packaging and shipping, for example: paper, poster board, cardboard, cloth, plastic film, foam, or any other dunnage material.

In some embodiments, an adjustable lateral entrance, narrower than the paper itself, provides an ability to adjust the lateral width of the dunnage, thereby adjusting paper output crumple pattern.

### FEATURE LIST

machine (100)
head unit (110)
housing (111)
entrance (112)
exit (113)
passage (114)
first side (114a)
second side (114B)
tapered walls (115)
lateral entrance (116)
post (117)
distance between posts (118)
slot (119)
dunnage roller system (120)
dunnage roller (121)
channel (121a)
outer surface (121b)
motor (122)
driving element (122a)
tensioner (123)
belt (124)
counter roller (125)
feeding tray (130)
cutter (140)
spool (150)
spool basket (160)
basket plates (161)
basket bars (162)
basket (163)
wheels (164)
securing arms (165)
stand (170)

What is claimed is:

1. A machine for converting spooled material into dunnage, the machine comprising:
a head unit, the head unit comprising:
a plurality of plates forming a housing;
the housing having an entrance, an exit, and a passage extending therethrough;
wherein the entrance has a first side and a second side, the first side of the entrance comprising two tapered walls extending outward and away from the entrance, thereby forming an adjustable lateral entrance;
a belt-driven dunnage roller system comprising:
a dunnage roller, a motor, and a tensioner each being rotationally connected by a belt and mounted inside the housing with the dunnage roller extending into the passage of the housing, adjacent to the second side of the housing entrance;
the dunnage roller comprising a channel extending around an outer surface of the wheel;
wherein the belt is configured to nest within the channel of the dunnage roller connecting the dunnage roller to the other components of the belt driven dunnage roller system;
a spring-mounted counter roller, disposed adjacent to the entrance of the housing and adjacent to the dunnage roller, the spring mounted counter roller being configured to abut the surface of the dunnage roller while rotating in a direction opposite the dunnage roller;
a feeding tray extending outwardly from the entrance of the housing adjacent to the adjustable lateral entrance; and
a cutter disposed adjacent to the exit of the housing;
characterized in that:
the head unit is configured to route the dunnage material from a spool, over the feeding tray, and into the adjustable lateral entrance of the housing;
wherein when the dunnage material encounters the walls of the adjustable lateral entrance, the dunnage material is folded into itself, crumpling the dunnage material laterally; and
wherein when the dunnage material passes between the belt driven dunnage roller and the spring mounted counter roller disposed adjacent to the entrance, the belt driven dunnage roller engages the dunnage material, crumpling the dunnage material vertically against the spring mounted counter roller, forming a dunnage product and forcing the dunnage product through the channel of the housing and out of the exit, allowing a user to extrude a desired amount of dunnage product out of the exit of the housing, and enabling the user to cut the dunnage product via the cutter disposed adjacent to the exit of the housing.

2. The machine of claim 1 further comprising:
a spool basket, the spool basket comprising:
a plurality of plates coupled together by a plurality of bars to form a basket; and
a plurality of wheels rotationally mounted inside the basket such that the spool of dunnage material can be placed inside the basket and can rotate inside the basket atop the plurality of wheels.

3. The machine of claim 1, the head unit further comprising:
a plurality of posts, the posts being adjustably positioned inside the adjustable lateral entrance of the head unit, with each post positioned on opposite sides of the opening;
wherein the user can set the density of the extruded dunnage product by adjusting a distance between the posts.

4. A machine for converting spooled material into dunnage, comprising:
a head unit and an entrance,
the head unit comprising:
a belt-driven dunnage roller system, the belt driven roller system including:
a motor,
at least one dunnage roller having a channel disposed about an outer surface thereof,
a belt configured to nest within the channel and further coupled to the motor,
wherein the belt is adapted to rotate the at least one dunnage roller as the motor turns, and
the entrance comprising two posts, wherein a distance between the two posts is adjustable for reconfiguring a density of the dunnage created by the machine.

5. The machine of claim 4, further comprising a stand, wherein the head unit is coupled to the stand.

6. The machine of claim 4, further comprising a spool basket, wherein the spool basket is adapted to attach to the stand.

7. The machine of claim 6, wherein the spool basket is configured to hold a spool containing spooled material.

8. The machine of claim 7, wherein the spool basket comprises a plurality of wheels collectively configured to allow rotation of the spool containing spooled material.

9. The machine of claim 4, wherein the head unit comprises a spring-mounted counter roller configured to provide bias force against one of the at least one dunnage roller for gripping and passing the spooled material through the head unit.

10. The machine of claim 4, further comprising a cutter disposed at an exit of the head unit and configured to cut the dunnage created by the machine.
